(19) United States
(12) Patent Application Publication
(10) Pub. No.: US 2023/0412304 A1
(43) Pub. Date: Dec. 21, 2023

(54) METHOD AND APPARATUS FOR PERFORMING LOW LATENCY STREAMING IN WIRELESS COMMUNICATION SYSTEM

(71) Applicant: SAMSUNG ELECTRONICS CO., LTD., Suwon-si (KR)

(72) Inventors: Seohyang KIM, Suwon-si (KR); Seungyoung SHIN, Suwon-si (KR); Chihyun CHO, Suwon-si (KR); Junho LEE, Suwon-si (KR)

(73) Assignee: SAMSUNG ELECTRONICS CO., LTD., Suwon-si (KR)

(21) Appl. No.: 18/224,695

(22) Filed: Jul. 21, 2023

Related U.S. Application Data
(63) Continuation of application No. PCT/KR2023/008551, filed on Jun. 20, 2023.

(30) Foreign Application Priority Data
Jun. 20, 2022 (KR) 10-2022-0075020
Mar. 24, 2023 (KR) 10-2023-0039238

(51) Int. Cl. H04L 1/00

(52) U.S. Cl. CPC H04L 1/0041; H04L 1/0009

(57) ABSTRACT

A method of a wireless communication system includes obtaining, by a first apparatus, network status information from the second apparatus, determining, by the first apparatus, a forward error correction (FEC) parameter, based on the network status information, generating, by the first apparatus, an FEC packet, based on the FEC parameter, transmitting, by the first apparatus and to a second apparatus, the FEC packet, transmitting, by the first apparatus and to the second apparatus, a plurality of frame packets corresponding to image content, based on a limited number of retransmissions.

### CROSS-REFERENCE TO RELATED APPLICATIONS

This application is a continuation of International Application No. PCT/KR2023/008551, filed on Jun. 20, 2023, in the Korean Intellectual Property Receiving Office, which based on and claims priority to Korean Patent Application No. 10-2023-0039238, filed on Mar. 24, 2023, in the Korean Intellectual Property Office, and Korean Patent Application No. 10-2022-0075020, filed on Jun. 20, 2022, in the Korean Intellectual Property Office, the disclosures of which are incorporated herein by reference in their entireties.

### BACKGROUND

### 1. Field

The disclosure relates to a wireless communication system, and more particularly, to a method and apparatus for performing low latency streaming based on link layer retransmission adaptation.

### 2. Description of Related Art

A user may watch videos by using a wireless device. More research is being conducted to develop a video streaming technology for providing a user with a high quality of experience (QoE). In particular, a streaming market scale records a high compound annual growth rate (CAGR). In order to satisfy sharply increasing demand, a low latency live streaming platform is being developed.

One difference between on-demand streaming and live streaming is a time at which video content is generated. For the on-demand streaming, a full image is completely prepared and stored in a server, whereas for the live streaming, an image is generated in units of frames and encoded in real time. Therefore, for the on-demand streaming, a video buffer size of a client may sufficiently increase to be adapted for a change in a network status (e.g., more than several tens of seconds). For example, when the network status is good, the client may fill a buffer with an image sequence while consuming video data in the buffer. Afterward, even when sudden network interruption occurs, as the buffer was filled when the network state was good, occurrence of an event may be hidden using the image sequence downloaded to the buffer.

In a live streaming scenario, an image sequence has to be generated in units of frames and then rapidly transmitted to a user, and image content has to be displayed in real time on a monitor of the client. Therefore, even when a network status of the client is good, data downloadable to a buffer may no longer exist. As a result, a video buffer size is limited to a short time, which makes it difficult to adapt to a change in a network status, such that video service provision may be frequency interrupted.

For an interactive streaming scenario including an augmented reality (AR) or virtual reality (VR) streaming or cloud game service, it is more difficult to solve such a problem. A user's motion including a key input and movement has to be rapidly transferred to a server and applied to a next video frame. Therefore, the server may immediately encode a new video frame and transmit the encoded frame to a remote client. Immediately after a client device receives the frame, the client device may rapidly decode the received video frame and render it on a screen. In order to provide a smooth and seamless streaming service to a user, all operations in one frame unit have to be completed within about 20 ms. After this time, the user may experience negative effects (e.g., the user may feel dizzy).

A technique of decreasing latency is important in AR streaming or VR streaming. Some related art solutions are implemented in an application layer (AL). For example, an operation of reducing the size of data to be transmitted, by predicting a field of view (FoV) of a user, or an operation of reducing encoding or decoding latency may be applied to reduce latency. In a wireless local area network (WLAN), channel status information may change according to time due to interference between communication channels.

Accordingly, a technology for low latency streaming via Wi-Fi streaming is required.

The technical problems of the disclosure are not limited to those aforementioned, and other unstated technical problems may be inferred from embodiments below.

### SUMMARY

Provided is a method of decreasing an entire transmission delay of an operation, performed by a first apparatus, of transmitting image content to a second apparatus, by adjusting, in a link layer, a limited number of retransmissions with respect to a plurality of frame packets associated with the image content.

According to an embodiment of the disclosure, an application layer obtains at least one recovered frame packet corresponding to a lost frame packet, based on a forward error correction (FEC) packet, such that an entire packet loss rate may be decreased and a high-performance low latency streaming service may be provided to a user.

Additional aspects will be set forth in part in the description which follows and, in part, will be apparent from the description, or may be learned by practice of the presented embodiments.

According to an aspect of the disclosure, a method of a wireless communication system may include obtaining, by a first apparatus, network status information from the second apparatus, determining, by the first apparatus, an FEC parameter, based on the network status information, generating, by the first apparatus, an FEC packet, based on the FEC parameter, transmitting, by the first apparatus and to a second apparatus, the FEC packet to the second apparatus, transmitting, by the first apparatus and to the second apparatus, a plurality of frame packets corresponding to image content, based on a limited number of retransmissions.

The network status information may include at least one of a transmission delay, a frame packet loss rate, a burst loss rate, and a residual loss rate.

The transmitting of the plurality of frame packets may include updating the limited number of retransmissions based on the network status information, and transmitting, to the second apparatus, the plurality of frame packets based on the updated limited number of retransmissions.

The network status information may include the transmission delay and the updating of the limited number of retransmissions may include comparing the transmission delay with a preset threshold delay and decreasing the limited number of retransmissions by one based on the transmission delay being greater than the preset threshold delay.

The network status information may include the frame packet loss rate and the updating of the limited number of retransmissions may include comparing the frame packet loss rate with a preset threshold loss rate based on the transmission delay being equal to or smaller than the preset threshold delay and increasing the limited number of retransmissions by one based on the frame packet loss rate being greater than the preset threshold loss rate.

The limited number of retransmissions may be determined by the second apparatus and may be received by the first apparatus from the second apparatus.

The FEC packet may be corresponding first timestamp information and each of the plurality of frame packets may include corresponding second timestamp information.

According to an aspect of the disclosure, a method of a wireless communication system may include receiving, by a second apparatus and from a first apparatus, at least one FEC packet and a plurality of frame packets corresponding to image content, identifying, by the second apparatus, at least one lost frame packet, obtaining, by the second apparatus, at least one recovered frame packet corresponding to the at least one lost frame packet based on the at least one FEC packet, obtaining, by the second apparatus, the image content, based on the received plurality of frame packets and the at least one recovered frame packet, and outputting, by the second apparatus, the image content.

The method may include determining, by the second apparatus, network status information, based on at least one of information corresponding to the plurality of frame packets and information corresponding to the at least one lost frame packet, and transmitting, by the second apparatus, the determined network status information to the first apparatus.

The information corresponding to the plurality of frame packets may include transmission timestamp information included in a header of a frame packet and reception timestamp information corresponding to a reception of the frame packet, and the network status information may include a transmission delay.

The information corresponding to the plurality of frame packets may include a sequence number included in a header of each frame packet of the plurality of frame packets, the information corresponding to the at least one lost frame packet may include a sequence number corresponding to the at least one lost frame packet and a number of lost frame packets of the at least one lost frame packet, and the network status information may include at least one of a frame packet loss rate, a burst loss rate, or a residual loss rate.

The network status information may be determined in units of frames and the network status information may be transmitted, by the second apparatus, in the units of frames to the first apparatus.

The method may include determining, by the second apparatus, a limited number of retransmissions for the plurality of frame packets corresponding to the image content and transmitting, by the second apparatus and to the first apparatus, the determined limited number of retransmissions.

According to an aspect of the disclosure, a first apparatus may include a transceiver, and at least one processor configured to obtain network status information from a second apparatus via the transceiver, determine an FEC parameter, based on the network status information, generate an FEC packet based on the FEC parameter, transmit the FEC packet to the second apparatus via the transceiver, and transmit, to the second apparatus via the transceiver, a plurality of frame packets corresponding to image content based on a limited number of retransmissions.

The network status information may include at least one of a transmission delay, a frame packet loss rate, a burst loss rate, and a residual loss rate.

The at least one processor may be further configured to update the limited number of retransmissions based on the network status information and transmit, to the second apparatus via the transceiver, the plurality of frame packets based on the updated limited number of retransmissions.

The network status information may include the transmission delay, and the at least one processor may be further configured to compare the transmission delay with a preset threshold delay and decrease the limited number of retransmissions by one based on the transmission delay being greater than the preset threshold delay.

The network status information may include the frame packet loss rate, and the at least one processor may be further configured to compare the frame packet loss rate with a preset threshold loss rate based on the transmission delay being equal to or smaller than the preset threshold delay and increase the limited number of retransmissions by one based on the frame packet loss rate being greater than the preset threshold loss rate.

The at least one processor may be further configured to receive the limited number of retransmissions from the second apparatus via the transceiver.

The FEC packet may include corresponding first timestamp information and each of the plurality of frame packets may include corresponding second timestamp information.

According to an aspect of the disclosure, a second apparatus may include a display, a transceiver, and at least one processor configured to receive, from a first apparatus via the transceiver, at least one FEC packet and a plurality of frame packets corresponding to image content, identify at least one lost frame packet, obtain at least one recovered frame packet corresponding to the at least one lost frame packet based on the at least one FEC packet, obtain the image content based on the received plurality of frame packets and the at least one recovered frame packet and output the image content via the display.

The at least one processor may be further configured to determine network status information based on at least one of information corresponding to the plurality of frame packets and information corresponding to the at least one lost frame packet and transmit the determined network status information to the first apparatus via the transceiver.

The information corresponding to the plurality of frame packets may include transmission timestamp information included in a header of a frame packet and reception timestamp information corresponding to a reception of the frame packet, and the network status information may include a transmission delay.

The information corresponding to the plurality of frame packets may include a sequence number included in a header of each frame packet, the information corresponding to the at least one lost frame packet may include a sequence number corresponding to the at least one lost frame packet and a number of lost frame packets of the at least one lost frame packet, and the network status information may include at least one of a frame packet loss rate, a burst loss rate, and a residual loss rate.

The at least one processor may be further configured to determine the network status information in units of frames and transmit the network status information in the units of frames to the first apparatus via the transceiver.

The at least one processor may be further configured to determine a limited number of retransmissions for the plurality of frame packets corresponding to the image content and transmit, to the first apparatus via the transceiver, the determined limited number of retransmissions.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram illustrating a low latency streaming method according to an embodiment of the disclosure;

FIG. 2 is a flowchart illustrating a method of a first apparatus transmitting image content to a second apparatus in a wireless communication system, according to an embodiment of the disclosure;

FIG. 3 is a flowchart illustrating a method of a second apparatus providing a low latency streaming service in a wireless communication system, according to an embodiment of the disclosure;

FIG. 4 is a diagram illustrating a method of updating a limited number of retransmissions, based on network status information, according to an embodiment of the disclosure;

FIGS. 5A and 5B are diagrams illustrating an operation performed in units of frames in a low latency streaming method according to an embodiment of the disclosure;

FIG. 6 is a diagram illustrating a configuration of the first apparatus transmitting image content in a wireless communication system, according to an embodiment of the disclosure; and

FIG. 7 is a diagram illustrating a configuration of the second apparatus providing a low latency streaming service in a wireless communication system, according to an embodiment of the disclosure.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms. It is to be understood that singular forms include plural referents unless the context clearly dictates otherwise. The terms including technical or scientific terms used in the disclosure may have the same meanings as generally understood by those skilled in the art.

Throughout the disclosure, the expression “at least one of a, b or c” indicates only a, only b, only c, both a and b, both a and c, both b and c, all of a, b, and c, or variations thereof.

In the disclosure, certain explanations of the aspects that are well known in the art may be omitted. By omitting unnecessary explanations, the essence of the disclosure may not be obscured and may be explicitly conveyed. The terms used in the specification are defined in consideration of functions used in the disclosure, and may be changed according to the intent or known methods of operators and users. Accordingly, definitions of the terms should be understood based on the entire description of the present specification.

Some elements in the drawings are exaggerated, omitted, or schematically illustrated. Also, the size of each element does not entirely reflect the actual size. In the drawings, the same or corresponding elements are denoted by the same reference numerals.

Advantages and features of the disclosure and methods of accomplishing the same may be understood more readily by reference to the following detailed descriptions of embodiments and accompanying drawings of the disclosure. The disclosure may, however, be embodied in many different forms and should not be construed as being limited to the embodiments set forth herein. Rather, these embodiments of the disclosure are provided such that the disclosure will be thorough and complete and will fully convey the concept of the disclosure to one of ordinary skill in the art

Throughout the specification, like reference numerals denote like elements. The terms used in the specification are defined in consideration of functions used in the disclosure, and may be changed according to the intent or commonly used methods of users or operators. Accordingly, definitions of the terms are understood based on the entire descriptions of the present specification.

In the disclosure, it will be understood that each block of flowchart illustrations, and combinations of blocks in the flowchart illustrations, may be implemented by computer program instructions. The computer program instructions may be provided to a processor of a general-purpose computer, special purpose computer, or other programmable data processing apparatus, such that the instructions, which are executed via the processor of the computer or other programmable data processing apparatus, generate means for performing functions specified in the flowchart block(s). The computer program instructions may also be stored in a memory that may direct the computer or other programmable data processing apparatus to function in a particular manner, such that the instructions stored in the memory may produce an article of manufacture including instruction means that perform the functions specified in the flowchart block(s). The computer program instructions may also be loaded onto the computer or other programmable data processing apparatus.

In addition, each block of the flowchart illustrations may represent a module, segment, or portion of code, which includes one or more executable instructions for performing specified logical function(s). In an embodiment of the disclosure, it should also be noted that the functions noted in the blocks may occur out of the order. For example, two blocks shown in succession may in fact be executed substantially concurrently or the blocks may sometimes be executed in the reverse order, depending upon the functionality involved.

The term “ . . . unit” as used in an embodiment of the disclosure refers to a software or hardware element, such as field-programmable gate array (FPGA) or application-specific integrated circuit (ASIC), which performs certain tasks. However, the term “ . . . unit” is not meant to be limited to software or hardware. A “ . . . unit” may be configured to be in an addressable storage medium or configured to operate one or more processors. In an embodiment of the disclosure, a “ . . . unit” may include, by way of example, elements, such as software elements, object-oriented software elements, class elements, and task elements, processes, functions, attributes, procedures, subroutines, segments of program code, drivers, firmware, microcode, circuitry, data, databases, data structures, tables, arrays, and variables. The functionality provided in the elements and “ . . . units“may be combined into fewer elements and” . . . units” or further separated into additional elements and “ . . . units”. In addition, in an embodiment of the disclosure, a “ . . . unit” may include one or more processors.

Hereinafter, terms indicating broadcasting information, terms indicating control information, terms related to communication coverage, terms indicating a state change (e.g., event), terms indicating network entities, terms indicating messages, terms indicating elements of an apparatus, or the like, as used in the following description, are exemplified for convenience of descriptions. Accordingly, the disclosure is not limited to the terms to be described below, and other terms indicating objects having equal technical meanings may be used.

Hereinafter, embodiments of the disclosure will now be described more fully with reference to the accompanying drawings.

A user equipment (UE) may include a mobile station (MS), a vehicle, a satellite, an airborne entity, a cellular phone, a smartphone, a computer, or a multimedia system enabled to perform a communication function.

Considering the development of wireless communication from generation to generation, technologies have been developed mainly for services targeting humans, such as voice calls, multimedia services, data services, and the like. Following the commercialization of 5^{th} generation (5G) communication systems, it is expected that connected devices, which are exponentially growing, will be connected to communication networks. Examples of things connected to networks may include vehicles, robots, drones, home appliances, displays, smart sensors connected to various infrastructures, construction machines, factory equipment, and the like. Mobile devices are expected to evolve in various form-factors such as augmented reality glasses, virtual reality headsets, hologram devices, and the like. In order to provide various services by connecting hundreds of billions of devices and things in the 6^{th} generation (6G) era, there have been ongoing efforts to develop enhanced 6G communication systems. For these reasons, 6G communication systems are referred to as beyond-5G systems.

6G communication systems will have a peak data rate of tera (i.e., 1,000 giga)-level bits per second (bps) and a radio latency less than 100 psec. That is, the 6G communication systems will be 50 times as fast as 5G communication systems and have 1/10 the radio latency thereof.

In order to achieve such a high data rate and an ultra-low latency, it has been considered to implement the 6G communication systems in a terahertz band (for example, 95 GHz to 3 THz bands). It is expected that, due to more severe path loss and atmospheric absorption in the terahertz bands than those in millimeter wave (mmWave) bands introduced in 5G, technologies capable of securing the signal transmission distance, that is, coverage, will become more important. It is necessary to develop, as major technologies for securing the coverage, radio frequency (RF) elements, antennas, novel waveforms having better coverage than orthogonal frequency division multiplexing (OFDM), beamforming and massive multiple input multiple output (MIMO), full dimensional MIMO (FD-MIMO), array antennas, and multi-antenna transmission technologies such as large-scale antennas. In addition, in order to improve the coverage of terahertz-band signals, there has been ongoing discussion on new technologies such as metamaterial-based lenses and antennas, a high-dimensional spatial multiplexing technology using orbital angular momentum (OAM), reconfigurable intelligent surface (RIS), and the like.

Moreover, in order to improve the spectral efficiency and the overall network performances, the following technologies have been developed for 6G communication systems, which include a full-duplex technology for enabling an uplink transmission and a downlink transmission to simultaneously use the same frequency resource at the same time, a network technology for using satellites, high-altitude platform stations (HAPS), and the like in an integrated manner, an improved network structure for supporting mobile base stations and the like and enabling network operation optimization and automation and the like, a dynamic spectrum sharing technology via collision avoidance based on a prediction of spectrum usage, a use of artificial intelligence (AI) in wireless communication for improvement of overall network operation by using AI in a designing phase for developing 6G and internalizing end-to-end AI support functions, and a next-generation distributed computing technology for overcoming the limit of UE computing ability through reachable super-high-performance communication and computing resources (such as mobile edge computing (MEC), clouds, and the like) over the network. In addition, through designing new protocols to be used in the 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of the 6G communication systems in hyper-connectivity, including person to machine (P2M) as well as machine to machine (M2M), will allow the next hyper-connected experience. In more detail, it is expected that services such as truly immersive extended reality (XR), high-fidelity mobile hologram, and digital replica can be provided through the 6G communication systems. In addition, services such as remote surgery for security and reliability enhancement, industrial automation, and emergency response will be provided through the 6G communication system, such that the technologies can be applied in various fields such as industry, medical care, automobiles, home appliances, and the like.

The demand for traffic in the mobile communication market increases due to the popularity of high-quality video streaming, introduction of augmented reality (AR) and virtual reality (VR) services, or the like. Also, there is an increasing interest for an interactive streaming service including AR or VR streaming, cloud games, or the like.

Recently, there is an increasing interest for a bidirectional streaming service in which a user can directly participate in, as opposed to a unidirectional on-demand video streaming service, and for example, entertainment image streaming techniques in various forms such as live streaming, 360-degree streaming, AR or VR streaming, cloud games, or the like are being lively developed.

As it is important to provide an image in real time in live streaming or the like, a packet that arrives late is no longer useful, and proper timing is much more important than stability in the service. Therefore, a service provider may use, as a transmission protocol, a user datagram protocol (UDP) that is unreliable but fast, instead of using a transmission control protocol (TCP) that is reliable but may cause long latency. Embodiments of the disclosure provide various loss recovery methods for complementing for unreliability of the UDP.

According to the development in display, graphic, and communication technologies, there is a need to provide a streaming service for content with a large size (4K, 8K, three dimensional (3D), 360, etc.). When provision of a low latency streaming service is implemented in a transmission layer (a link layer), for example a field of view (FoV) of a user is predicted to delete data of an area irrelevant to the provision of the service, such that a size of data to be transmitted or received may be decreased. In an embodiment of the disclosure, provision of a low latency streaming service may be implemented not in a transmission layer but in an application layer (AL).

In an embodiment of the disclosure, a wireless local area network (WLAN) via which a data packet is transmitted or received is highly affected by an ambient environment and is variable, such that it is difficult to predict when a data transmission/reception channel status deteriorates. For example, a frame loss rate of a wireless link in a WLAN may be about 20 to 80% and a packet loss rate thereof may be about 4%.

For low latency streaming, an encoding or decoding time in an AL may be decreased or a size of image data to be transmitted may be decreased. When a wireless status is not good (e.g., below standards, non-optimal, etc.), the number of retransmissions in a link layer may be increased, and furthermore, latency may also be increased.

Therefore, according to an embodiment of the disclosure, the number of retransmissions in a link layer may be limited to decrease latency, and in order to compensate for a packet loss due to the limit in the number of retransmissions, forward error correction (FEC) in an AL may be used. This operation may cause an increase in a frame packet loss rate due to a limited number of retransmissions but such side effects may be compensated by using FEC in an AL.

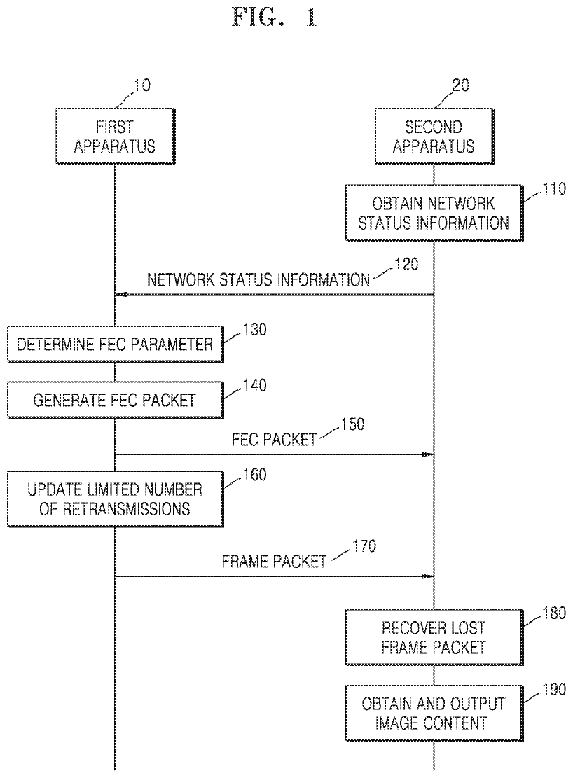

FIG. 1 is a diagram illustrating a low latency streaming method according to an embodiment of the disclosure.

Referring to FIG. 1, a low latency streaming system may include a first apparatus 10 for transmitting image content to a second apparatus 20, and the second apparatus 20 for providing a low latency streaming service.

In operation 110, the second apparatus 20 may obtain network status information. In an embodiment of the disclosure, the network status information may include at least one of a transmission delay, a frame packet loss rate, a burst loss rate, or a residual loss rate.

In operation 120, the second apparatus 20 may transmit, to the first apparatus 10, the network status information obtained in operation 110. In an embodiment of the disclosure, the second apparatus 20 may calculate the network status information for every frame unit and may transmit the updated status information to the first apparatus 10.

In operation 130, the first apparatus 10 may determine an FEC parameter, based on the network status information. The FEC parameter may be used in an operation of generating an FEC packet for an FEC operation.

In operation 140, the first apparatus 10 may generate an FEC packet, based on the determined FEC parameter. In an embodiment of the disclosure, the FEC packet may include timestamp information corresponding thereto.

In operation 150, the first apparatus 10 may transmit the generated FEC packet to the second apparatus 20. In an embodiment of the disclosure, the FEC packet may be transmitted in a separate operation from a frame packet associated with image content.

In operation 160, the first apparatus 10 may update a limited number of retransmissions, based on the network status information.

In an embodiment of the disclosure, the network status information may include the transmission delay. The operation of updating a limited number of retransmissions may include comparing the transmission delay with a preset threshold delay, and decreasing the limited number of retransmissions by 1 based on the transmission delay being greater than the preset threshold delay. For example, the preset threshold delay may be received from another apparatus. A case in which a current transmission delay is greater than the preset threshold delay indicates that a level of the current transmission delay is higher than a level of maximum latency requested for the system to provide a high-quality streaming service. Therefore, the system may perform adjustment in a link layer by decreasing the limited number of retransmissions by 1, such that the transmission delay becomes smaller than the requested level of the maximum latency.

In an embodiment of the disclosure, the network status information may include the frame packet loss rate. When the transmission delay is equal to or smaller than the preset threshold delay (i.e., when the transmission delay is not greater than the preset threshold delay), the operation of updating a limited number of retransmissions may include comparing the frame packet loss rate with a preset threshold loss rate, and increasing the limited number of retransmissions by 1 based on the frame packet loss rate being greater than the preset threshold loss rate. A case in which the current transmission delay is equal to or smaller than the preset threshold delay indicates that a level of the current transmission delay is not higher than a level of the maximum latency requested for the system to provide a high-quality streaming service. Also, a case in which the frame packet loss rate is greater than the preset threshold loss rate indicates that many of packets requested for the system to provide the streaming service are lost. In this case, retransmission of the packets is requested to provide image content. Therefore, the system may perform adjustment in the link layer by increasing the limited number of retransmissions by 1, such that a level of a packet loss is decreased.

In an embodiment of the disclosure, the limited number of retransmissions may be determined by the second apparatus 20 and received before operation 160 is performed. For example, when the low latency streaming method does not include the operation of updating a limited number of retransmissions, the first apparatus 10 may transmit, to the second apparatus 20, a plurality of frame packets based on the updated number of retransmissions.

In operation 170, the first apparatus 10 may transmit, to the second apparatus 20, a plurality of frame packets associated with (e.g., corresponding to) the image content, based on the limited number of retransmissions. Each of the plurality of frame packets may include timestamp information corresponding thereto.

In an embodiment of the disclosure, based on the limited number of retransmissions being updated, the plurality of frame packets may be transmitted to the second apparatus 20, based on the updated limited number of retransmissions.

In operation 180, the second apparatus 20 may identify whether there is a lost frame packet, and may obtain at least one recovered frame packet corresponding to at least one lost frame packet, based on at least one FEC packet.

In an embodiment of the disclosure, not only a frame packet but also an FEC packet may be lost. For example, a possibility a packet transmitted by a transmitting apparatus may be lost during transmission regardless of information included in the packet is the same for all packets. The reason why a packet is lost in a wireless communication system is not dependent upon information of the packet but is dependent upon a change in a channel environment between a transmitting apparatus and a receiving apparatus according to time, and thus, not only a frame packet but also an FEC packet may be lost.

When the frame packet is lost, the lost frame packet may be recovered based on the FEC packet, but, when the FEC packet is lost, a packet recovery operation is not performed on the FEC packet.

When a plurality of frame packets are lost, it may not be possible to recover 100% of the lost frame packets even if a forward error message is used.

In operation 190, the second apparatus 20 may obtain the image content, based on the received plurality of frame packets and the at least one recovered frame packet. Afterward, the second apparatus 20 may output the image content.

In an embodiment of the disclosure, the method may further include determining network status information, based on at least one of information corresponding to the plurality of frame packets and information corresponding to the lost frame packet, and transmitting the determined network status information to the first apparatus 10. For example, the network status information determined based on at least one of the information corresponding to the plurality of frame packets of a current frame unit or the information corresponding to the lost frame packet may be used in an operation of updating an FEC parameter or a limited number of retransmissions in a next frame unit.

In an embodiment of the disclosure, the information corresponding to the plurality of frame packets may include transmission timestamp information included in a header of a frame packet and reception timestamp information with respect to reception of the frame packet. The network status information may include the transmission delay. For example, the second apparatus 20 may determine an amount of latency from a time point of transmission of a specific packet to a time point of reception thereof, via timestamp information included in headers of the plurality of frame packets.

In an embodiment of the disclosure, the information corresponding to the plurality of frame packets may include a sequence number included in a header of each frame packet. The information corresponding to the lost frame packet may include a sequence number corresponding to the lost frame packet and the number of lost frame packets. The network status information may include at least one of a frame packet loss rate, a burst loss rate, or a residual loss rate. For example, the second apparatus 20 may determine a loss of a specific sequence number, based on sequence numbers included in the headers of the plurality of frame packets, and may determine a packet loss rate, based on the number of packets corresponding to lost sequence numbers.

In an embodiment of the disclosure, the network status information may be determined in a frame unit, and may be transmitted in the frame unit to the first apparatus 10. In an embodiment of the disclosure, the network status information may be determined at regular time intervals, and may be transmitted to the first apparatus 10 at regular time intervals or for the frame unit. The network status information may be determined at various intervals, and may be transmitted to the first apparatus 10 at various intervals.

In an embodiment of the disclosure, the FEC parameter may be determined for each frame unit. In this case, FEC may be performed on only one image frame. (For example, when a specific image frame and FEC parameter information are transmitted together, only the image frame corresponding to the parameter information may be recovered. If FEC information affects multiple image frames, it has to wait until all the multiple image frames are received so as to recover a loss of a specific image frame, and this may cause long latency).

In an embodiment of the disclosure, the method may further include: determining a limited number of retransmissions for a plurality of frame packets associated with image content; and transmitting, to the first apparatus 10, the determined limited number of retransmissions. For example, the first apparatus 10 may not directly update or determine a limited number of retransmissions but may receive it from the second apparatus 20 and use it.

In an embodiment of the disclosure, the second apparatus 20 may constantly monitor a network status by estimating an available bandwidth and measuring a packet loss rate, a burst loss rate, and network latency. Afterward, the second apparatus 20 may transmit information of the periodic monitoring to the first apparatus 10. While receiving a feedback from the second apparatus 20, the first apparatus 10 may determine a data rate being most appropriate for a real-time network status, and an FEC parameter.

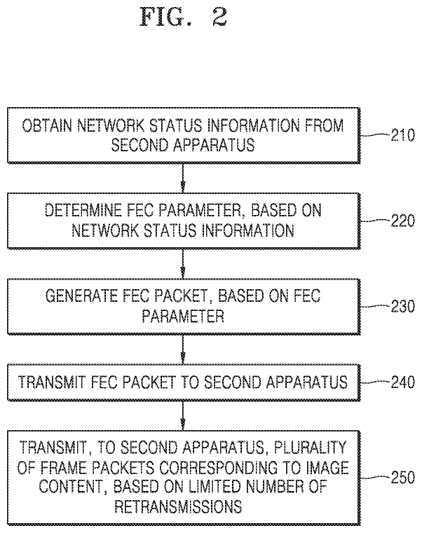

FIG. 2 is a flowchart illustrating a method of a first apparatus transmitting image content to a second apparatus in a wireless communication system, according to an embodiment of the disclosure.

In operation 210, the first apparatus obtains network status information from the second apparatus. Operation 210 of FIG. 2 may correspond to operation 120 of FIG. 1 described above.

In operation 210, the first apparatus determines an FEC parameter, based on the network status information. Operation 220 of FIG. 2 may correspond to operation 130 of FIG. 1 described above.

In operation 230, the first apparatus generates an FEC packet, based on the FEC parameter. Operation 230 of FIG. 2 may correspond to operation 140 of FIG. 1 described above.

In operation 240, the first apparatus transmits the generated FEC packet to the second apparatus. Operation 240 of FIG. 2 may correspond to operation 150 of FIG. 1 described above.

In operation 250, the first apparatus transmits, to the second apparatus, a plurality of frame packets corresponding to the image content, based on a limited number of retransmissions. Operation 250 of FIG. 2 may correspond to operations 160 to 170 of FIG. 1 described above.

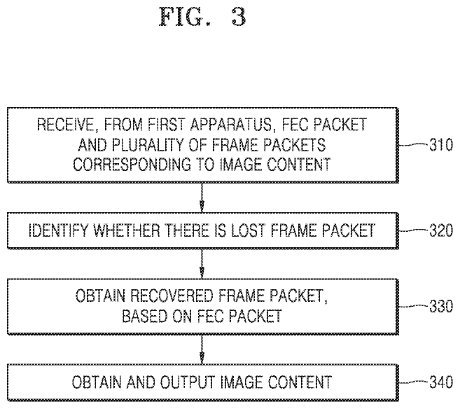

FIG. 3 is a flowchart illustrating a method of a second apparatus providing a low latency streaming service in a wireless communication system, according to an embodiment of the disclosure.

In operation 310, the second apparatus receives, from a first apparatus, an FEC packet and a plurality of frame packets associated with image content. Operation 310 of FIG. 3 may correspond to operations 150 to 170 of FIG. 1 described above.

In operation 320, the second apparatus identifies whether there is a lost frame packet, and based on it being identified that there is a lost frame packet, in operation 330, the second apparatus obtains a recovered frame packet corresponding to the lost frame packet, based on the FEC packet. Operations 320 to 330 of FIG. 3 may correspond to operation 180 of FIG. 1 described above.

In operation 340, the second apparatus obtains and outputs the image content. Operation 340 of FIG. 3 may correspond to operation 190 of FIG. 1 described above.

Based on the second apparatus having received the plurality of frame packets associated with the image content from the first apparatus detecting a loss or an error in received data, the second apparatus may request the first apparatus for retransmission or may immediately recover lost or defective data by itself by using received overlapping data. The former is an example of backward error correction (BEC), and the latter is an example of FEC. In the BEC, the first apparatus retransmits same data whenever the second apparatus requests the first apparatus for packet retransmission, and thus, the first apparatus does not need to transmit overlapping data. Instead, each retransmission operation requests a time longer than a round trip time (RTT) of data. For example, a minimum RTT is requested for a time period in which the second apparatus transmits a retransmission request message to the first apparatus and then the first apparatus retransmits a packet, in response to the request message. Therefore, when an RTT value is increased, time overhead of BEC is increased. In the BEC, the first apparatus may transmit original data with overlapping data. When there is an error in source data, the second apparatus may use the overlapping data. As FEC causes data redundancy, the FEC requests a larger bandwidth than the BEC.

When the FEC is used in a link layer, a bit error of a frame may be recovered. When the FEC is used in an application layer, a lost packet may be recovered. According to an embodiment of the disclosure, a packet loss due to low performance of a link layer may be compensated for by using application layer FEC in a wireless communication system.

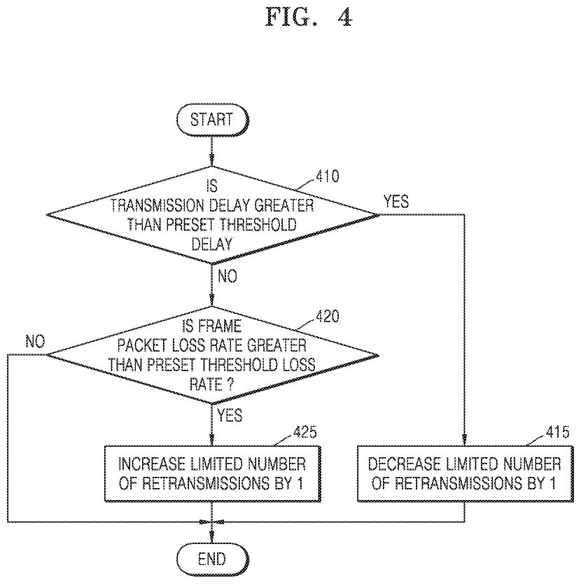

FIG. 4 is a diagram illustrating a method of updating a limited number of retransmissions, based on network status information, according to an embodiment of the disclosure.

Operations 410 to 425 of FIG. 4 may correspond to operation 160 of FIG. 1 described above. Referring to FIG. 4, a first apparatus may update a limited number of retransmissions, based on network status information.

In an embodiment of the disclosure, the network status information may include a transmission delay. In operation 410, the first apparatus may compare the transmission delay with a preset threshold delay. Based on the transmission delay being greater than the preset threshold delay (YES in operation 410), the method proceeds to operation 415. In operation 415, the first apparatus may decrease the limited number of retransmissions by 1.

For example, the preset threshold delay may be received from another apparatus. A case in which a current transmission delay is greater than the preset threshold delay indicates that a level of the current transmission delay is higher than a level of maximum latency requested for the system to provide a high-quality streaming service. Therefore, the system may perform adjustment in a link layer by decreasing the limited number of retransmissions by 1, such that the transmission delay becomes smaller than the requested level of the maximum latency.

Based on the transmission delay being equal to or smaller than the preset threshold delay (NO in operation 410), the method proceeds to operation 420. In an embodiment of the disclosure, the network status information may include a frame packet loss rate. In operation 420, the first apparatus may compare the frame packet loss rate with a preset threshold loss rate. Based on the frame packet loss rate being greater than the preset threshold loss rate (YES in operation 420), the method proceeds to operation 425. In operation 425, the first apparatus may increase the limited number of retransmissions by 1. Based on the frame packet loss rate not being greater than the preset threshold loss rate (NO in operation 420), the method may end.

A case in which the current transmission delay is equal to or smaller than the preset threshold delay indicates that a level of the current transmission delay is not higher than a level of the maximum latency requested for the system to provide a high-quality streaming service. Also, a case in which the frame packet loss rate is greater than the preset threshold loss rate indicates that many of packets requested for the system to provide the streaming service are lost. In this case, retransmission of the packets is requested to provide image content. Therefore, the system may perform adjustment in the link layer by increasing the limited number of retransmissions by 1, such that a level of a packet loss is decreased.

In an embodiment of the disclosure, a limited number of retransmissions may be determined by a second apparatus and received from the second apparatus before the method of FIG. 4 is started. Afterward, the first apparatus may update the limited number of retransmissions received from the second apparatus via the method of FIG. 4.

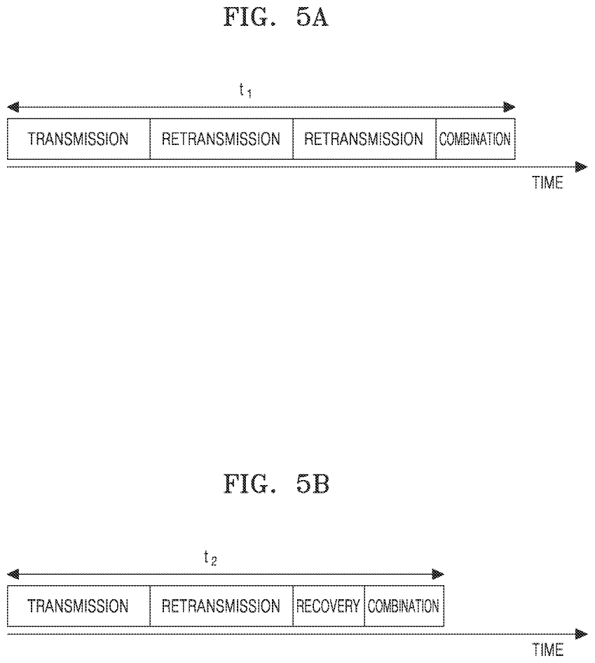

FIGS. 5A and 5B are diagrams illustrating an operation performed in a frame unit in a low latency streaming method according to an embodiment of the disclosure.

When a wireless channel quality is not good in Wi-Fi communication, packet retransmission may be performed 10 times or more on overage in a link layer. The more the number of attempts of packet retransmission is increased, the more the service provision latency is increased.

FIG. 5A illustrates a case in which a user datagram protocol (UDP) is used as a transmission protocol. When the UDP is used as the transmission protocol, there is no loss recovery mechanism for a lost packet. Therefore, there is no difference between a packet loss rate and a remaining end-to-end loss rate. Also, in this case, latency of a streaming operation is increased due to buffering of waiting for a packet that is not arrived yet until a deadline of a specific image frame.

FIG. 5B illustrates a case to which a method of providing a low latency streaming service according to an embodiment of the disclosure is applied. In the case of FIG. 5B, a lost packet may be rapidly recovered as an FEC scheme is used, and a full video frame may be immediately transmitted to a display or a decoder included in the second apparatus. Therefore, a buffering time may be decreased so that latency and a packet loss rate may be decreased.

When comparing FIGS. 5A and 5B, it is apparent that the case of FIG. 5B is better than the case of FIG. 5A, in terms of latency. For example, in the case of FIG. 5A, time t₁ is requested until an output of one frame is prepared, and in the case of FIG. 5B, time t₂ is requested until an output of one frame is prepared. t₁ indicates a time taken, after transmission of an initial packet, for an operation of performing retransmission two times for a lost frame packet not being received, and then combining image content, and t₂ indicates a time taken, after transmission of an initial packet, for an operation of performing retransmission one time for a lost frame packet not being received, and then combining a packet recovered from a lost packet with received packets.

In general, a time taken for retransmission is long when reviewed within one frame unit. Therefore, in a case where retransmission is decreased by 1 and an FEC operation is additionally performed, a time taken for the case is short, compared to a case where retransmission is performed two times (t₁>t₂).

By decreasing an average packet processing time of the link layer by limiting the number of retransmissions, a video frame including multiple packets may be transmitted in a short time. Therefore, an image frame transmitted from the first apparatus to the second apparatus may be rapidly transmitted to the display or the decoder, such that both network latency and a buffering time may be decreased.

When a limit in retransmission is increased from 0 to 2, an opportunity of data retransmission is increased so that a network loss rate may be decreased.

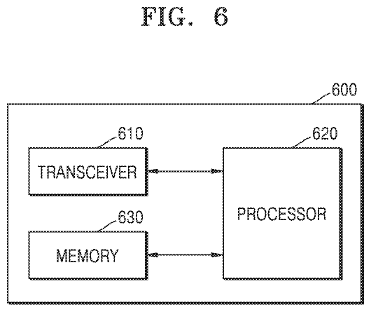

FIG. 6 is a diagram illustrating a configuration of the first apparatus transmitting image content in a wireless communication system, according to an embodiment of the disclosure.

In an embodiment of the disclosure, an apparatus 600 may be the first apparatus shown in FIG. 1.

Referring to FIG. 6, the apparatus 600 may include a transceiver 610, a processor 620, and a memory 630. The transceiver 610, the processor 620, and the memory 630 of the apparatus 600 may operate according to the aforementioned communication schemes of the apparatus 600. However, elements of the apparatus 600 are not limited to the example above. For example, the apparatus 600 may include more elements than the aforementioned elements or may include fewer elements than the aforementioned elements. In an embodiment of the disclosure, the transceiver 610, the processor 620, and the memory 630 may be implemented as one chip. Also, the processor 620 may include one or more processors.

A transmitter and a receiver of the apparatus 600 may be collectively referred to as the transceiver 610, and the transceiver 610 may transmit or receive a signal to or from another apparatus. The signal the apparatus 600 transmits to or receives from the other apparatus may include control information and data. To this end, the transceiver 610 may include a radio frequency (RF) transmitter for up-converting a frequency of and amplifying signals to be transmitted, and an RF receiver for low-noise-amplifying and down-converting a frequency of received signals. However, this is merely an example of the transceiver 610, and thus elements of the transceiver 610 are not limited to the RF transmitter and the RF receiver.

Also, the transceiver 610 may perform functions for transmitting or receiving a signal via a wireless channel. For example, the transceiver 610 may receive a signal via a wireless channel and output the signal to the processor 620, and may transmit a signal output from the processor 620, via a wireless channel.

The memory 630 may store programs and data necessary for operations of the apparatus 600. Also, the memory 630 may store control information or data which are included in a signal obtained by the apparatus 600. The memory 630 may be implemented as a storage medium including a read only memory (ROM), a random access memory (RAM), a hard disk, a compact disc (CD)-ROM, a digital versatile disc (DVD), or the like, or any combination thereof. Alternatively, the memory 630 may not be separately arranged but may be included in the processor 620. The memory 630 may be configured as a volatile memory, a non-volatile memory, or a combination of a volatile memory and a non-volatile memory. The memory 630 may provide stored data, in response to a request by the processor 620.

The processor 620 may control a series of processes to allow the apparatus 600 to operate according to the aforementioned embodiment of the disclosure. For example, the processor 620 may receive a control signal and a data signal by using the transceiver 610, and may process the received control signal and the received data signal. The processor 620 may transmit the processed control signal and the processed data signal by using the transceiver 610. Also, the processor 620 may record data to and read data from the memory 630. The processor 620 may perform functions of a protocol stack which are requested by the communication rules. To do so, the processor 620 may include at least one processor or a micro-processor. In an embodiment of the disclosure, a part of the transceiver 610 or the processor 620 may be referred to as a communication processor (CP).

The processor 620 may refer to one or more processors. In this case, the one or more processors may each be a general-purpose processor such as a central processing unit (CPU), an application processor (AP), a digital signal processor (DSP), or the like, a graphics-dedicated processor such as a graphics processing unit (GPU), a vision processing unit (VPU) or the like, or an AI-dedicated processor such as a neural processing unit (NPU). For example, each of the one or more processors is the AI-dedicated processor, the AI-dedicated processor may be designed to have a hardware structure specialized for processing of a specific AI model.

In an embodiment of the disclosure, the apparatus 600 may include the transceiver 610 and at least one processor 620. The at least one processor 620 may be configured to obtain network status information from the second apparatus via the transceiver 610, determine an FEC parameter, based on the network status information, generate an FEC packet, based on the FEC parameter, transmit the FEC packet to the second apparatus via the transceiver 610, and transmit, to the second apparatus via the transceiver 610, a plurality of frame packets associated with the image content, based on a limited number of retransmissions.

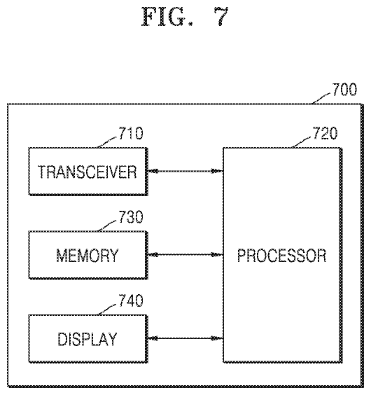

FIG. 7 is a diagram illustrating a configuration of the second apparatus providing a low latency streaming service in a wireless communication system, according to an embodiment of the disclosure.

In an embodiment of the disclosure, an apparatus 700 may be the second apparatus shown in FIG. 1.

Referring to FIG. 7, the apparatus 700 may include a transceiver 710, a processor 720, a memory 730, and a display 740. The transceiver 710, the processor 720, the memory 730, and the display 740 of the apparatus 700 may operate according to the aforementioned communication schemes of the apparatus 700. However, elements of the apparatus 700 are not limited to the example above. For example, the apparatus 700 may include more elements than the aforementioned elements or may include fewer elements than the aforementioned elements. In an embodiment of the disclosure, the transceiver 710, the processor 720, the memory 730, and the display 740 may be implemented as one chip. Also, the processor 720 may include one or more processors.

A transmitter and a receiver of the apparatus 700 may be collectively referred to as the transceiver 710, and the transceiver 710 may transmit or receive a signal to or from another apparatus. The signal the apparatus 700 transmits to or receives from the other apparatus may include control information and data. To this end, the transceiver 710 may include a RF transmitter for up-converting a frequency of and amplifying signals to be transmitted, and an RF receiver for low-noise-amplifying and down-converting a frequency of received signals. However, this is merely an example of the transceiver 710, and thus elements of the transceiver 710 are not limited to the RF transmitter and the RF receiver.

Also, the transceiver 710 may perform functions for transmitting or receiving a signal via a wireless channel. For example, the transceiver 710 may receive a signal via a wireless channel and output the signal to the processor 720, and may transmit a signal output from the processor 720, via a wireless channel.

The memory 730 may store programs and data necessary for operations of the apparatus 700. Also, the memory 730 may store control information or data which are included in a signal obtained by the apparatus 700. The memory 730 may be implemented as a storage medium including a ROM, a RAM, a hard disk, a CD-ROM, a DVD, or the like, or any combination thereof. Alternatively, the memory 730 may not be separately arranged but may be included in the processor 720. The memory 730 may be configured as a volatile memory, a non-volatile memory, or a combination of a volatile memory and a non-volatile memory. The memory 730 may provide stored data, in response to a request by the processor 720.

The processor 720 may control a series of processes to allow the apparatus 700 to operate according to the aforementioned embodiments of the disclosure. For example, the processor 720 may receive a control signal and a data signal by using the transceiver 710, and may process the received control signal and the received data signal. The processor 720 may transmit the processed control signal and the processed data signal by using the transceiver 710. Also, the processor 720 may record data to and read data from the memory 730. The processor 720 may perform functions of a protocol stack which are requested by the communication rules. To do so, the processor 720 may include at least one processor or a micro-processor. In an embodiment of the disclosure, a part of the transceiver 710 or the processor 720 may be referred to as a CP.

The processor 720 may refer to one or more processors. In this case, the one or more processors may each be a general-purpose processor such as a CPU, an AP, a DSP, or the like, a graphics-dedicated processor such as a GPU, a VPU or the like, or an AI-dedicated processor such as a NPU. For example, each of the one or more processors is the AI-dedicated processor, the AI-dedicated processor may be designed to have a hardware structure specialized for processing of a specific AI model.

The display 740 may include a panel. The display 740 may include at least one of a liquid crystal display, a thin film transistor-liquid crystal display, an organic light-emitting diode display, a flexible display, a 3D display, an electrophoretic display, or a laser display.

In an embodiment of the disclosure, the apparatus 700 may include the transceiver 710 and at least one processor 720. The at least one processor 720 may be configured to receive, from a first apparatus via the transceiver 710, at least one FEC packet and a plurality of frame packets associated with image content, identify whether there is a lost frame packet, based on it being identified that there is a lost frame packet, obtain at least one recovered frame packet corresponding to the at least one lost frame packet, based on the at least one FEC packet, obtain the image content, based on the received plurality of frame packets and the at least one recovered frame packet, and output the image content via the display 740.

Various embodiments of the disclosure may be implemented or supported by one or more computer programs, and the computer programs may be formed of computer-readable program codes and may be embodied on a computer-readable medium. In the disclosure, the terms “application” and “program” may refer to one or more computer programs, software components, instruction sets, procedures, functions, objects, classes, instances, associated data, or part thereof, which are appropriately implemented in computer-readable program codes. The “computer-readable program codes” may include various types of computer codes including source codes, target codes and executable codes. The “computer-readable medium” may include various types of medium accessible by a computer, such as a ROM, RAM, a hard disk drive (HDD), a CD, a DVD or other various types of memory.

Also, the computer-readable storage medium may be provided in the form of a non-transitory storage medium. Here, the term ‘non-transitory storage medium’ means that the storage medium is a tangible entity and may exclude wired, wireless, optical, or other communication links via which temporary electrical or other signals are transmitted. The ‘non-transitory storage medium’ does not distinguish that data is stored semi-permanently or temporarily on the storage medium. For example, the non-transitory storage medium may include a buffer in which data is temporarily stored. The computer-readable medium may include any usable medium that may be accessed by computers, volatile and non-volatile mediums, and detachable and non-detachable mediums. The computer-readable medium includes a medium for permanently storing data, and a medium for storing data which can be overwritten afterward, i.e., a rewritable optical disk or an erasable memory device.

According to an embodiment of the disclosure, a method according to various embodiments of the disclosure may be provided in a computer program product. The computer program product may be traded between a seller and a purchaser as a commodity. The computer program product may be distributed in the form of a machine-readable storage medium (e.g., CD-ROM), or may be distributed online (e.g., downloaded or uploaded) through an application store or directly between two user devices (e.g., smart phones). For online distribution, at least a part of the computer program product (e.g., a downloadable app.) may be temporarily generated or be at least temporarily stored in a machine-readable storage medium such as a manufacturer's server, an application store's server, or a memory of a relay server.

A method, performed by a first apparatus, of transmitting image content to a second apparatus in a wireless communication system may include obtaining network status information from the second apparatus, determining an FEC parameter, based on the network status information, generating an FEC packet, based on the FEC parameter, transmitting the FEC packet to the second apparatus, and transmitting, to the second apparatus, a plurality of frame packets associated with the image content, based on a limited number of retransmissions.

In an embodiment of the disclosure, the network status information may include at least one of a transmission delay, a frame packet loss rate, a burst loss rate, or a residual loss rate.

In an embodiment of the disclosure, the transmitting of, to the second apparatus, the plurality of frame packets, based on the limited number of retransmissions may include updating the limited number of retransmissions, based on the network status information, and transmitting, to the second apparatus, the plurality of frame packets, based on the updated limited number of retransmissions.

In an embodiment of the disclosure, the network status information may include the transmission delay. The updating of the limited number of retransmissions may include comparing the transmission delay with a preset threshold delay, and decreasing the limited number of retransmissions by 1 based on the transmission delay being greater than the preset threshold delay.

In an embodiment of the disclosure, the network status information may further include the frame packet loss rate. The updating of the limited number of retransmissions may further include comparing the frame packet loss rate with a preset threshold loss rate based on the transmission delay being equal to or smaller than the preset threshold delay, and increasing the limited number of retransmissions by 1 based on the frame packet loss rate being greater than the preset threshold loss rate.

In an embodiment of the disclosure, the limited number of retransmissions may be determined by the second apparatus and may be received from the second apparatus.

In an embodiment of the disclosure, the FEC packet and each of the plurality of frame packets may include timestamp information corresponding thereto.

A method, performed by a second apparatus, of providing a low latency streaming service in a wireless communication system may include receiving, from a first apparatus, at least one FEC packet and a plurality of frame packets associated with image content, identifying that there is at least one lost frame packet, obtaining at least one recovered frame packet corresponding to the at least one lost frame packet, based on the at least one FEC packet, obtaining the image content, based on the received plurality of frame packets and the at least one recovered frame packet, and outputting the image content.

In an embodiment of the disclosure, the method may further include determining network status information, based on at least one of information corresponding to the plurality of frame packets or information corresponding to the at least one lost frame packet, and transmitting the determined network status information to the first apparatus.

In an embodiment of the disclosure, the information corresponding to the plurality of frame packets may include transmission timestamp information included in a header of a frame packet and reception timestamp information with respect to reception of the frame packet. The network status information may include a transmission delay.

In an embodiment of the disclosure, the information corresponding to the plurality of frame packets may include a sequence number included in a header of each frame packet. The information corresponding to the lost frame packet may include a sequence number corresponding to the lost frame packet and the number of lost frame packets. The network status information may include at least one of a frame packet loss rate, a burst loss rate, or a residual loss rate.

In an embodiment of the disclosure, the network status information may be determined in a frame unit, and may be transmitted in the frame unit to the first apparatus.

In an embodiment of the disclosure, the method may further include determining a limited number of retransmissions for the plurality of frame packets associated with the image content, and transmitting, to the first apparatus, the determined limited number of retransmissions.

A first apparatus transmitting image content to a second apparatus in a wireless communication system may include a transceiver, and at least one processor. The at least one processor may be configured to obtain network status information from the second apparatus via the transceiver, determine an FEC parameter, based on the network status information, generate an FEC packet, based on the FEC parameter, transmit the FEC packet to the second apparatus via the transceiver, and transmit, to the second apparatus via the transceiver, a plurality of frame packets associated with the image content, based on a limited number of retransmissions.

A second apparatus providing a low latency streaming service in a wireless communication system may include a display, a transceiver, and at least one processor. The at least one processor may be configured to receive, from a first apparatus via the transceiver, at least one FEC packet and a plurality of frame packets associated with image content, identify that there is at least one lost frame packet, obtain at least one recovered frame packet corresponding to the at least one lost frame packet, based on the at least one FEC packet, obtain the image content, based on the received plurality of frame packets and the at least one recovered frame packet, and output the image content via the display.

While the disclosure has been particularly shown and described with reference to the accompanying drawings, in which embodiments of the disclosure are shown, the disclosure may be embodied in many different forms without changing the technical concept or essential features of the disclosure. For example, the aforementioned method may be performed in a different order, and/or the aforementioned systems, structures, devices, circuits, etc., may be combined in different combinations from what is described above, or replaced or substituted by other components or equivalents thereof, in order to obtain appropriate results. Thus, it should be understood that the embodiments described herein should be considered in a descriptive sense only and not for purposes of limitation. For example, configuring elements that are singular forms may be executed in a distributed fashion, and also, configuring elements that are distributed may be combined and then executed.

The embodiments of the disclosure disclosed in the specification and the drawings provide merely specific examples to easily describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

1. A method, performed by a first apparatus of a wireless communication system, the method comprising:
obtaining network status information from the second apparatus;
determining a forward error correction (FEC) parameter, based on the network status information;
generating an FEC packet, based on the FEC parameter;
transmitting the FEC packet to the second apparatus; and
transmitting, to the second apparatus, a plurality of frame packets corresponding to image content, based on a limited number of retransmissions.

2. The method of claim 1, wherein the network status information comprises at least one of a transmission delay, a frame packet loss rate, a burst loss rate, or a residual loss rate.

3. The method of claim 2, wherein the transmitting of the plurality of frame packets comprises:
updating the limited number of retransmissions based on the network status information; and
transmitting, to the second apparatus, the plurality of frame packets based on the updated limited number of retransmissions.

4. The method of claim 3, wherein the network status information comprises the transmission delay, and
wherein the updating of the limited number of retransmissions comprises:
comparing the transmission delay with a preset threshold delay; and
decreasing the limited number of retransmissions by one based on the transmission delay being greater than the preset threshold delay.

5. The method of claim 4, wherein the network status information further comprises the frame packet loss rate, and
wherein the updating of the limited number of retransmissions further comprises:
comparing the frame packet loss rate with a preset threshold loss rate based on the transmission delay being equal to or smaller than the preset threshold delay; and
increasing the limited number of retransmissions by one based on the frame packet loss rate being greater than the preset threshold loss rate.

6. The method of claim 1, wherein the limited number of retransmissions is determined by the second apparatus and is received by the first apparatus from the second apparatus.

7. The method of claim 1, wherein the FEC packet comprises corresponding first timestamp information, and
wherein each of the plurality of frame packets comprises corresponding second timestamp information.

8. A method, performed by a second apparatus of a wireless communication system, the method comprising:
receiving, from a first apparatus, at least one forward error correction (FEC) packet and a plurality of frame packets corresponding to image content;
identifying at least one lost frame packet;
obtaining at least one recovered frame packet corresponding to the at least one lost frame packet based on the at least one FEC packet;
obtaining the image content, based on the received plurality of frame packets and the at least one recovered frame packet; and
outputting the image content.

9. The method of claim 8, further comprising:
determining network status information, based on at least one of information corresponding to the plurality of frame packets or information corresponding to the at least one lost frame packet; and
transmitting the determined network status information to the first apparatus.

10. The method of claim 9, wherein the information corresponding to the plurality of frame packets comprises transmission timestamp information included in a header of a frame packet and reception timestamp information corresponding to a reception of the frame packet, and
wherein the network status information comprises a transmission delay.

11. The method of claim 9, wherein the information corresponding to the plurality of frame packets comprises a sequence number included in a header of each frame packet of the plurality of frame packets,
wherein the information corresponding to the at least one lost frame packet comprises a sequence number corresponding to the at least one lost frame packet and a number of lost frame packets of the at least one lost frame packet, and
wherein the network status information comprises at least one of a frame packet loss rate, a burst loss rate, or a residual loss rate.

12. The method of claim 9, wherein the network status information is determined in units of frames, and
wherein the network status information is transmitted, by the second apparatus, in the units of frames to the first apparatus.

13. The method of claim 8, further comprising:
determining, by the second apparatus, a limited number of retransmissions for the plurality of frame packets corresponding to the image content; and
transmitting, by the second apparatus and to the first apparatus, the determined limited number of retransmissions.

14. A first apparatus, comprising:
a transceiver; and
at least one processor configured to:
obtain network status information from a second apparatus via the transceiver,
determine a forward error correction (FEC) parameter, based on the network status information,
generate an FEC packet based on the FEC parameter,
transmit the FEC packet to the second apparatus via the transceiver, and
transmit, to the second apparatus via the transceiver, a plurality of frame packets corresponding to image content based on a limited number of retransmissions.
